(19) United States
(12) Patent Application Publication
(10) Pub. No.: US 2022/0257038 A1
(43) Pub. Date: Aug. 18, 2022

(54) BEVERAGE CONTAINER HOLDING ASSEMBLY

(71) Applicants: Larry Bettinger, Buffalo, WY (US); Pati Bettinger, Buffalo, WY (US)

(72) Inventors: Larry Bettinger, Buffalo, WY (US); Pati Bettinger, Buffalo, WY (US)

(21) Appl. No.: 17/176,293

(22) Filed: Feb. 16, 2021

(51) Int. Cl. A47G 23/02; A45F 5/00; F16B 2/08

(52) U.S. Cl. CPC A47G 23/0208; F16B 2/08; A45F 5/00

(57) ABSTRACT

A beverage container holding assembly includes a housing that has a bottom wall and a perimeter wall attached to and extending upwardly from the bottom wall. The housing has an upper end having a well extending therein. The well receives a beverage container and retain the beverage container in an upright position. A coupler is mounted on housing and engages a shaft. The coupler is rotatable relative to the housing such that the coupler is engageable with a vertically or horizontally orientated shaft.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

(1) Field of the Invention.

The disclosure relates to beverage holding device and more particularly pertains to a new beverage holding device for holding a variety of beverage containers including cans, bottles, and wine glasses.

(2) Description of Related Art including information disclosed under 37 CFR 1.97 and 1.98.

The prior art relates to beverage holding devices which are used to receive and hold in an upright position a beverage holding container in a convenient location to its user.

### BRIEF SUMMARY OF THE INVENTION

An embodiment of the disclosure meets the needs presented above by generally comprising a housing that has a bottom wall and a perimeter wall attached to and extending upwardly from the bottom wall. The housing has an upper end having a well extending therein. The well is configured to receive a beverage container and retain the beverage container in an upright position. A coupler is mounted on housing and is configured to engage a shaft. The coupler is rotatable relative to the housing such that the coupler is selectively engageable with a vertically or horizontally orientated shaft.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a beverage container holding assembly according to an embodiment of the disclosure.

FIG. 2 is a front view of an embodiment of the disclosure.

FIG. 3 is a bottom view of an embodiment of the disclosure.

FIG. 4 is a rear view of an embodiment of the disclosure.

FIG. 5 is a cross-sectional view of an embodiment of the disclosure taken along line 5-5 of FIG. 3.

FIG. 6 is a top view of an embodiment of the disclosure.

FIG. 7 is a rear isometric view of the embodiment of the disclosure shown in FIG. 6.

### DETAILED DESCRIPTION OF THE INVENTION

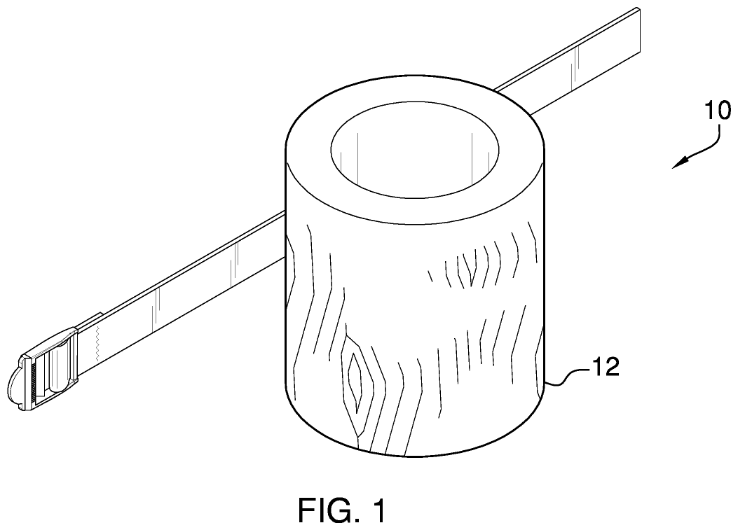

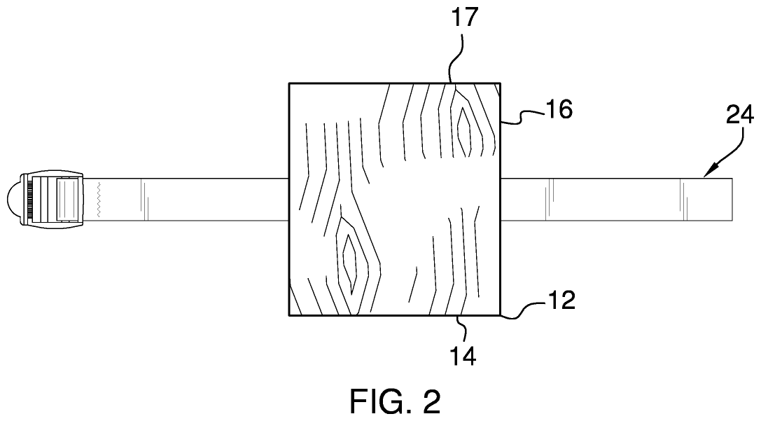

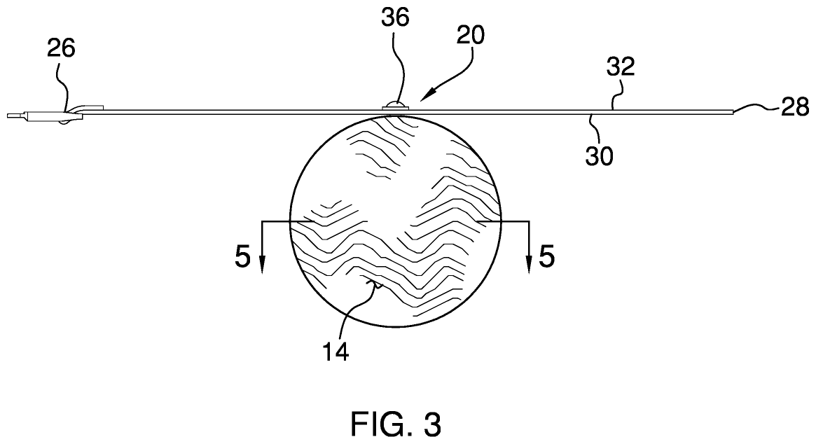

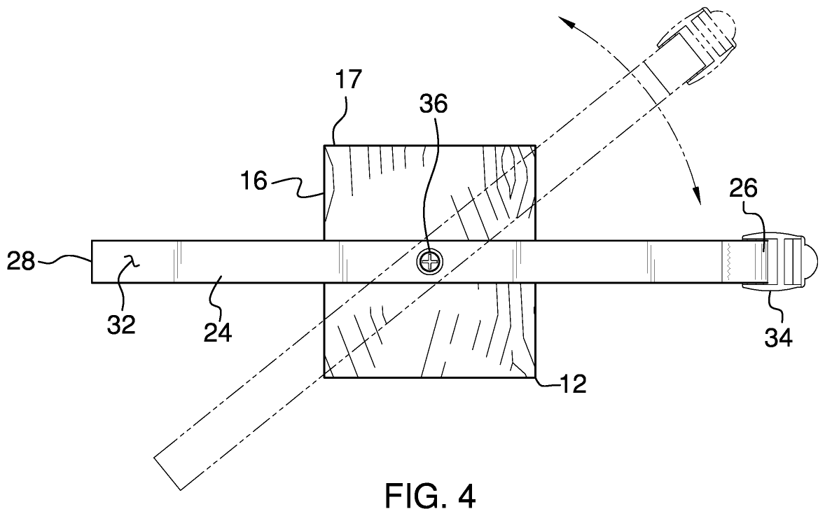

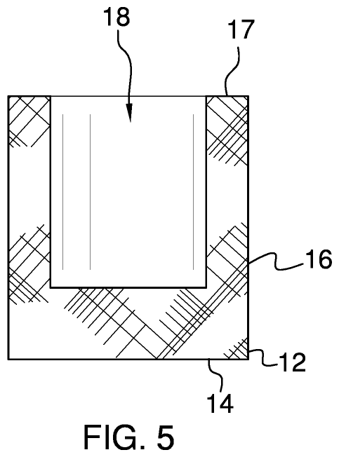

With reference now to the drawings, and in particular to FIGS. 1 through 7 thereof, a new beverage holding device embodying the principles and concepts of an embodiment of the disclosure and generally designated by the reference numeral 10 will be described.

As best illustrated in FIGS. 1 through 7, the beverage container holding assembly 10 generally comprises a housing 12 that has a bottom wall 14 and a perimeter wall 16 attached to and extends upwardly from the bottom wall 14. The housing 12 has an upper end 17 having a well 18 extending therein. While the well 18 may have alterative shapes, most typically the well 18 will have a cylindrically shape. The well 18 will usually have a diameter that is between 3.00 inches and 3.50 inches and a depth that is equal to at least 4.0 inches and no greater than 4.50 inches. The well 18 is configured to receive a beverage container and retain the beverage container, including bottles, cans, cups, wine glasses, and the like in an upright position. The housing 12 may be unitary structure such as plastics, elastomers, and metals. However, the housing 12 may be formed out of a wood material such as, in particular, a log having a diameter of less than 7.0 inches wherein the log is cut lengthwise and one of its ends defines the upper end 17 which is bored out to form the well 18.

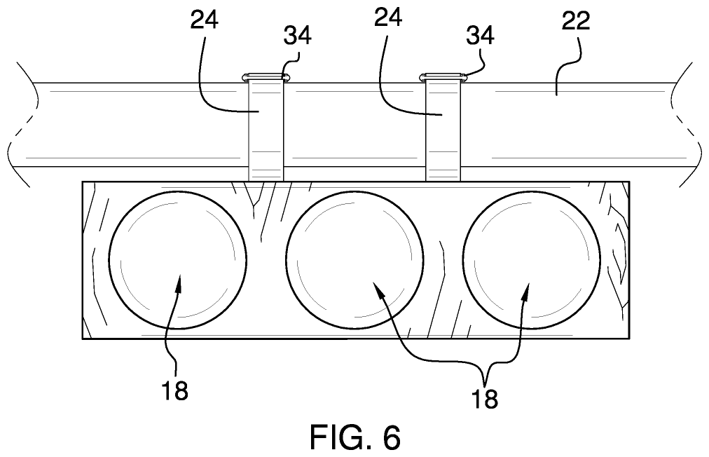

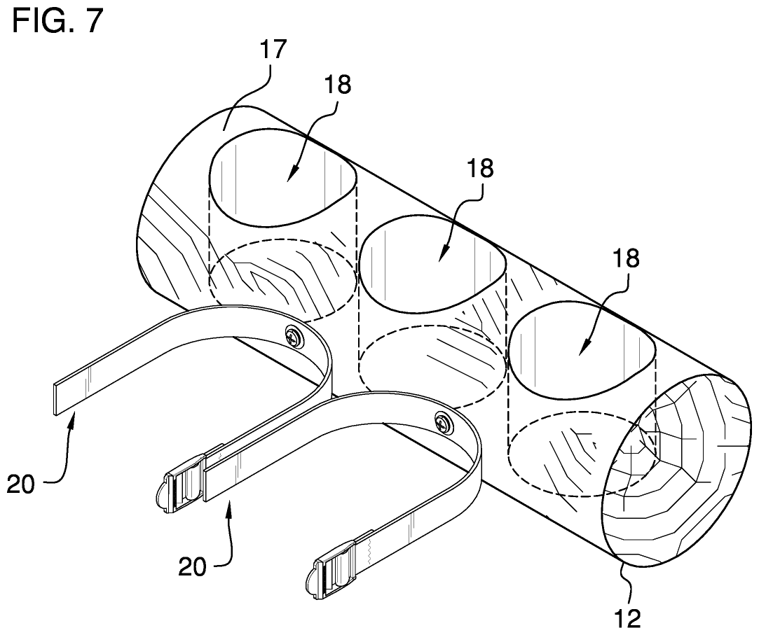

A coupler 20 is mounted on housing 12 and is configured to engage a shaft 22 to support the housing 12 on the shaft 22. However, the coupler 20 is rotatable relative to the housing 12 such that the coupler 20 is engageable with a vertically or horizontally orientated shaft 22. The shaft 22 may comprise an armrest of a chair, a leg of chair, a horizontal railing, a spindle holding up a railing, and the like. This allows a user of the assembly to position the housing 12 in a convenient location relative to the user. The coupler 20 is positioned above a center of gravity of the housing 12, wherein the center of gravity is most typically positioned nearer the bottom wall 14 than the upper end 17. This will help retain the housing 12 in an upright condition. As shown in the embodiments of FIGS. 6 and 7, the assembly 10 may include more than one coupler 20.

In one embodiment, the coupler 20 may include a strap 24 that is elongated and has a first end 26, a second end 28, a first side 30 and a second side 32. The strap 24 may be comprised of any conventional material such as natural or synthetic woven fibers. The strap 24 will generally have a length from the first end 26 to the second end 28 that is between 10.0 inches and 20.0 inches. A securing member 34 releasably secures the strap 24 to itself to retain the strap 24 in a closed loop and in removable engagement with the shaft 22. The securing member 34 may include a slide buckle, buckles including first and second mating members, hook and loop fasteners, snaps, buttons, and the like. The method of securing the strap 24 into the closed loop is not germane to the function of the assembly 10 and therefore any securing member 34 conventional to straps, belts, tiedowns and the like may be utilized. A fastener 36 pivotally coupling the strap 24 to the perimeter wall 16 such that the first side 30 faces and abuts an outer surface of the perimeter wall 16. The fastener 36 may include a rod, for example, extending through the strap 24 and into the perimeter wall 16 wherein the strap 24 is rotatable about the rod. The rod may include a conventional threaded screw.

In use, as user of the assembly 10 selects a shaft 22 onto which the housing 12 is to be mounted. The strap 24 is rotated until the strap 24 is orientated correctly to secure the housing 12 to the shaft 22 such that the upper end 17 faces an upward direction. The coupler 24 is then attached to the shaft 22 and, if the coupler 20 is a strap 24, tightened to frictionally engage the shaft 22. The housing 12 is then used to hold a beverage container including cups, wine glasses, beverage cans, beverage bottles and the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mountable beverage container holder assembly comprising:
a housing having a bottom wall and a perimeter wall being attached to and extending upwardly from the bottom wall, the housing having an upper end having a well extending therein, the well being configured to receive a beverage container and retain the beverage container in an upright position;
a coupler being mounted on housing, the coupler being configured to engage a shaft, the coupler being rotatable relative to the housing such that the coupler is engageable with a vertically or horizontally orientated shaft.

2. The mountable beverage container holder assembly according to claim 1, wherein the well has a cylindrically shape.

3. The mountable beverage container holder assembly according to claim 2, wherein the well has a diameter being between 3.00 inches and 3.50 inches, the well having a depth being equal to at least 4.0 inches and no greater than 4.50 inches.

4. The mountable beverage container holder assembly according to claim 1, wherein the well has a smallest diameter being between 3.00 inches and 3.50 inches, the well having a depth being equal to at least 4.0 inches and no greater than 4.50 inches.

5. The mountable beverage container holder assembly according to claim 1, wherein the coupler is positioned above a center of gravity of the housing, the center of gravity being positioned nearer the bottom wall than the upper end.

6. The mountable beverage container holder assembly according to claim 1, wherein coupler includes:
a strap being elongated and having a first end, a second end, a first side and a second side;
a securing member releasably securing the strap to itself to retain the strap in a closed loop and in removable engagement with the shaft; and
a fastener pivotally coupling the strap to the perimeter wall such that the first side abuts an outer surface of the perimeter wall.

7. The mountable beverage container holder assembly according to claim 6, wherein the strap has a length from the first end to the second being between 10.0 inches and 20.0 inches.

8. The mountable beverage container holder assembly according to claim 1, wherein the upper end has a plurality of wells extending therein, the wells each having a same size and shape relative to each other.

9. The mountable beverage container holder assembly according to claim 8, wherein the well has a smallest diameter being between 3.00 inches and 3.50 inches, the well having a depth being equal to at least 4.0 inches and no greater than 4.50 inches.

10. The mountable beverage container holder assembly according to claim 9, wherein coupler includes:
a strap being elongated and having a first end, a second end, a first side and a second side;
a securing member releasably securing the strap to itself to retain the strap in a closed loop and in removable engagement with the shaft; and
a fastener pivotally coupling the strap to the perimeter wall such that the first side abuts an outer surface of the perimeter wall.

11. A mountable beverage container holder assembly comprising:
a housing having a bottom wall and a perimeter wall being attached to and extending upwardly from the bottom wall, the housing having an upper end having a well extending therein, the well having a cylindrically shape, the well having a diameter being between 3.00 inches and 3.50 inches, the well having a depth being equal to at least 4.0 inches and no greater than 4.50 inches, the well being configured to receive a beverage container and retain the beverage container in an upright position;
a coupler being mounted on housing, the coupler being configured to engage a shaft, the coupler being rotatable relative to the housing such that the coupler is engageable with a vertically or horizontally orientated shaft, the coupler being positioned above a center of gravity of the housing, the center of gravity being positioned nearer the bottom wall than the upper end, the coupler including:
a strap being elongated and having a first end, a second end, a first side and a second side, the strap having a length from the first end to the second being between 10.0 inches and 20.0 inches;
a securing member releasably securing the strap to itself to retain the strap in a closed loop and in removable engagement with the shaft; and
a fastener pivotally coupling the strap to the perimeter wall such that the first side abuts an outer surface of the perimeter wall.
